(19) United States
(12) Patent Application Publication
(10) Pub. No.: US 2016/0078464 A1
(43) Pub. Date: Mar. 17, 2016

(54) ENHANCED MOBILE REWARDS PLATFORM

(71) Applicant: Jana Mobile, Inc., San Francisco, CA (US)

(72) Inventors: Benjamin P. Olding, Cambridge, MA (US); Craig Lancaster, Mansfield, MA (US)

(21) Appl. No.: 14/483,613

(22) Filed: Sep. 11, 2014

(51) Int. Cl. G06Q 30/02

(52) U.S. Cl. CPC G06Q 30/0217; G06Q 30/0267

(57) ABSTRACT

A system and a method for distributing rewards to consumers of mobile devices in exchange for preferred consumer actions are disclosed. A reward server of the system obtains a reward offering from a reward provider, which specifies the reward and required consumer actions associated with the reward. The reward server creates a clickable link for the reward and presents the clickable link to the consumer. The consumer can perform various actions through the clickable link and the reward server monitors the consumer actions. Responsive to the verification of the consumer and the consumer actions, the reward server provides the corresponding reward in terms of a predefined amount of free mobile airtime to the consumer.

### BACKGROUND

This disclosure relates generally to electronic consumer services, and particularly to providing rewards to consumers using an enhanced mobile reward platform.

Emerging markets often require marketers to effectively reach their consumers. One marketing technique is to put advertising dollars directly into the pockets of the consumers by targeted mobile-based advertisement campaigns. However, it is challenging for the marketers to directly reach a large number of consumers using traditional ways, such as traditional mail, newspapers, magazines, electronic mails, and websites. Global corporations need a platform that can be easily integrated and configured to understand, acquire, and retain emerging consumers, such as a platform that is seamlessly integrating with reward providers' back-end billing systems while effectively tracking consumers' reward worthy actions and providing corresponding rewards to the consumers.

### SUMMARY

Embodiments of a solution provide rewards in a form of free mobile airtime to consumers in exchange for certain consumer actions, e.g., completing a marking survey. In one embodiment, a reward server obtains a reward offering from a reward provider. The reward provider provides reward information, such as value of the reward, expiration date and required consumer actions (e.g., completing a marketing survey) in exchange for the reward. The reward server creates a clickable link for the reward (e.g., a URL to a webpage having the reward information) and presents the clickable link to a client device of the consumer, e.g., the consumer's mobile phone. The clickable link allows the reward server to convert the value of the reward in various currencies into a uniform format, such as a number of minutes of free mobile airtime.

The reward server monitors the consumer actions with the clickable link. Clicking the link by the consumer may enable a required consumer action associated with the reward, such as conducting a marketing survey specified by the reward provider. Responsive to the consumer having performed the required consumer action, the reward server verifies the consumer and the consumer actions. Responsive to the verification of the consumer and the consumer action, the reward server provides the reward to the verified consumer.

### BRIEF DESCRIPTION OF THE FIGURES

FIG. 1 is a block diagram of a communications environment for distributing rewards to consumers of client devices according to one embodiment.

FIG. 2 is a block diagram illustrating computer modules within an exemplary architecture of a reward server according to one embodiment.

FIG. 3 is a flowchart illustrating a method for providing a reward to consumers based on consumer actions with a clickable link of the reward according to one embodiment.

FIG. 4 illustrates interactions among a consumer of a mobile device, a reward server and a reward provider for reward distribution according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A solution to effectively providing rewards to consumers in emerging markets is provided. The solution presents rewards as clickable links, monitors consumers' actions with the clickable links, and provides corresponding rewards based on the monitored consumer actions. The solution enhances the consumer experience by providing an easy access to various reward offerings from reward providers and by shielding the consumers from complicated communications, such as billing, directly with the reward providers. On the other hand, the solution provides an effective reward platform for reward providers to effectively reach a large number of targeted consumers of the reward providers and to promote consumer engagement to drive sales, registrations, application installs, view views, photo uploads and product purchases.

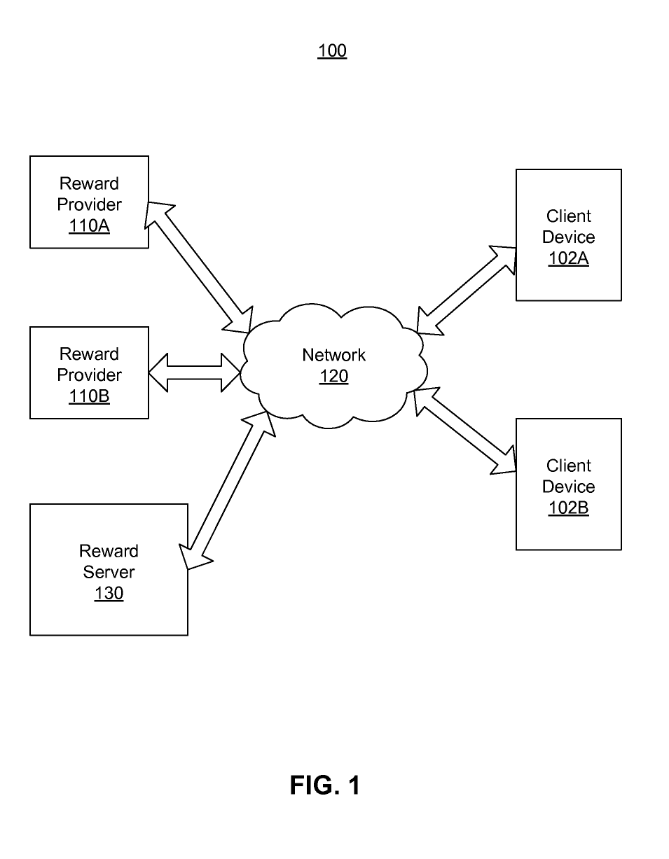

FIG. 1 is a block diagram of a communications environment 100 for distributing rewards to consumers of client devices according to one embodiment. The environment 100 includes multiple client devices 102 (depicted by way of example in FIG. 1 as client devices 102A and 102B), two reward providers 110A and 110B and a reward server 130 connected by a network 120. Other embodiments may include additional and different elements other than the one illustrated in FIG. 1.

Generally, a reward provider 110A/110B provides products or services (e.g., mobile services, consumer products) for sale at various merchants, from which consumers make purchases. To promote its products, the reward provider 110 may provide rewards (e.g., discounted coupons) to consumers in exchange for preferred consumer actions. In one embodiment, the reward provider 110 communicates with the reward server 130 regarding various offerings of rewards and required consumer actions associated with the rewards (e.g., completing a survey). The reward server 130 acts as a proxy for the reward provider 110 to present the rewards in clickable links, which enable consumers to perform the required consumer actions associated with the rewards. The reward server 130 monitors the consumer actions associated with the rewards and distributes the rewards to qualified consumers based on the consumer actions.

A client device 102A/102B is a computing device capable of receiving user input as well as transmitting and/or receiving phone calls and data via the network 120. In one embodiment, a client device 102 may be a device having computer functionality, such as a personal digital assistant (PDA), mobile telephone, smart-phone or similar device. The client devices 102 are configured to communicate via the network 120. In one embodiment, a client device 102 executes an application allowing a user of the client device 102 to interact with the reward server 130. For example, a client device 102 executes a browser application to enable interaction between the client device 102 and the reward server 130 via the network 120.

A user of the client device 102 uses the client device 102 to view rewards, receive rewards upon completing required consumer actions associated with rewards, register for rewards and redeem received rewards through the reward server 130. In one embodiment, the users of the client device 102 are prepaid subscribers of mobile service plans provided by mobile carriers. The prepaid subscribers receive reward offerings, such as free mobile airtime, from one or more mobile carriers through the reward server 130 in exchange of performing the required consumer actions associated with the rewards. Upon completing the required consumer actions associated with a reward, the prepaid subscribers receive free mobile airtime from the reward server 130.

The client devices 102 are configured to communicate via the network 120, which may comprise any combination of voice and data networks, using both wired and wireless communication systems and in one embodiment includes the Internet. In one embodiment, the network 120 uses standard communications technologies and/or protocols. Thus, the network 120 may include links using technologies such as public switched telephone network (PSTN), Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

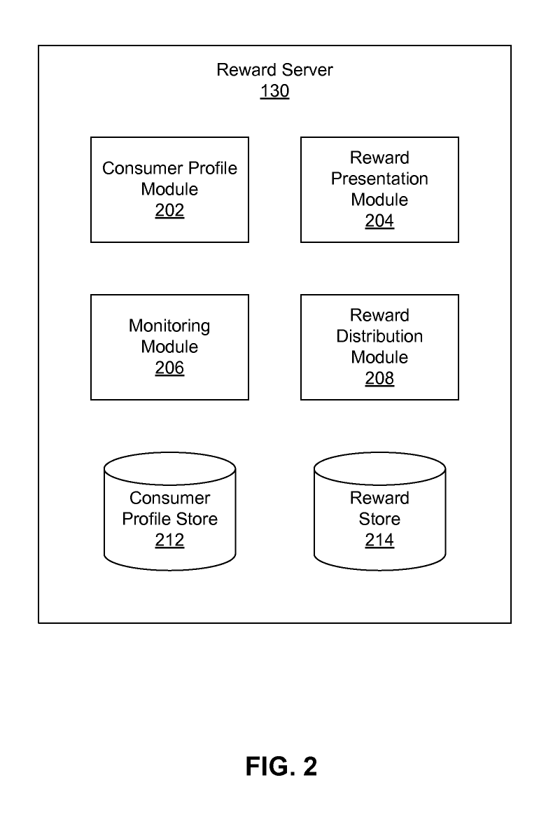

A reward provider 110 is coupled to the network 120 for communicating with the reward server 130. In one embodiment, the reward provider 110 communicates information describing reward offerings, e.g., discounted coupons for certain products, to the reward server 130. The information describing reward offerings may include information on the products or services to which the rewards are designated, service terms, reward provider information, and corresponding reward information, such as, rewards value (e.g., the value of the discount of a coupon), required consumer actions in exchange of the reward, redemption conditions, survey questions, target consumers, validation requirements and expiration dates. Since the reward provider 110 may not directly distribute rewards to consumers, but through the reward server 130, the reward provider 110 may also provide payment information describing methods, amount and conditions to pay the reward server 130 for acting as the proxy of the reward provider 110. In one embodiment, the rewards from the reward providers 110 are stored in a reward store, such as the reward store 214 illustrated in FIG. 2.

A reward provider 110 specifies required consumer actions for receiving a reward. Types of consumer actions associated with a reward include trial (clicking a clickable link of a reward, registration, application downloads), engagement (watching a video, uploading a photo, completing a survey), advocacy (referring a friend), and product purchase (airtime rebates). Taking completing a marketing survey as an example, a consumer is required to answer the marketing survey as a condition of receiving the reward, which can be provided to the consumers in a form of free mobile airtime. Alternatively, the consumer is encouraged to answer the survey for future reward opportunities. The marketing survey may include demographic and/or service-related questions. The reward server 130 collects consumer demographic information and purchase history to customize rewards based on consumer demographic information.

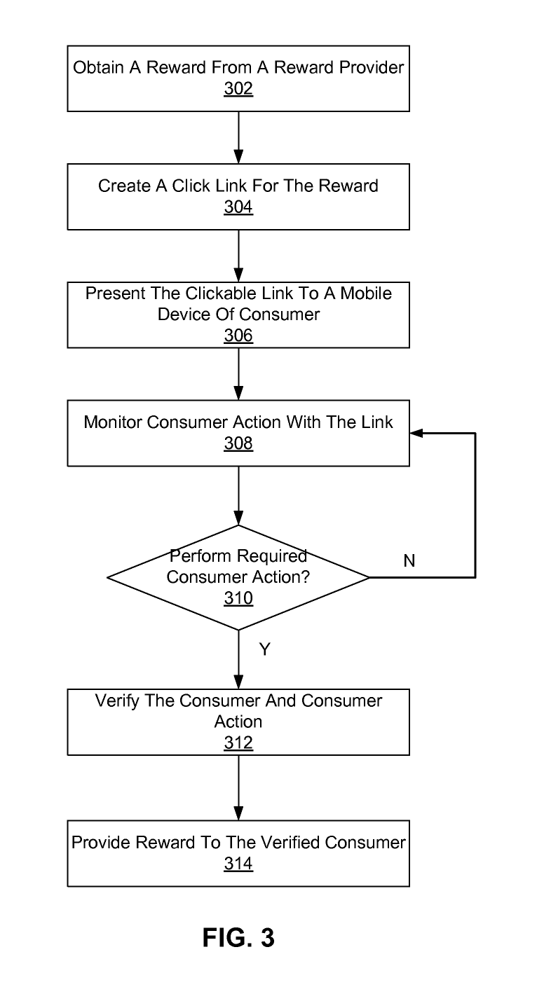

The reward server 130 obtains the rewards offerings from the reward providers 110 and provides the rewards offerings to consumers. In one embodiment, the reward server 130 purchases the reward offerings from the reward providers 110 and provides the reward offerings to targeted consumers defined in the offerings. Upon a consumer performing a required action associated with a reward, such as completing a survey provided by a reward provider 110, the reward server 130 provides the reward in a form of free mobile airtime to the consumer. The reward server 130, in turn, requests payment from the reward provider 110 for the services provided for the reward provider 110, e.g., providing the reward to the targeted consumer in exchange for a consumer action required by the reward provider 110. Details of the reward server 130 are further described with reference to FIG. 2 and FIG. 3 below.

### Reward Server Architecture

FIG. 2 is a block diagram illustrating computer modules within an exemplary architecture of the reward server 130 according to one embodiment. The reward server 130 includes a consumer profile module 202, a reward presentation module 204, a monitoring module 206, a reward distribution module 208, a consumer profile store 212 and a reward store 214. Other embodiments may include different or additional modules. Likewise, the modules may perform different or additional functions in some embodiments.

A consumer profile module 202 collects consumer information. Examples of consumer information include biographic, demographic, and other types of descriptive information of a consumer, such as gender, age, address, hobbies or preferences, educational history, work experience, mobile phone numbers and mobile services subscribed by the consumers and the like. Consumer information may also include consumer actions associated with rewards, such as registration of services, application downloads, watching a promotion video, uploading a photo (e.g., a copy of a purchase receipt), completing a marketing survey, referring a friend and rebating airtime of a mobile service.

Each consumer is described by a consumer profile based on consumer information collected by the reward server 130. A consumer profile includes declarative information about the consumer that has received and claimed one or more rewards at the reward server 130. In one embodiment, a consumer profile includes multiple data fields, each data field describing one or more attributes of the corresponding consumer based on the consumer information. The consumer profile store 212 stores consumer profiles and related information, such as references to rewards received by consumers, performed consumer actions and reward redemption events.

The reward presentation module 204 presents rewards provided by the reward providers 110 to consumers. In one embodiment, the reward presentation module 204 presents a reward as a clickable link through social networking means, such as a universal resource locator (URL) to a webpage of a website managed by the reward server 130. Responsive to consumer clicking the link of the reward, the reward presentation module 204 presents information that allows the consumer to perform the required consumer action, such as presenting a marketing survey to the consumer. In one embodiment, the reward presentation module 204 converts the value of a reward from various types of currencies used by consumers in different countries into a uniform format, e.g., minutes of mobile airtime.

The monitoring module 206 monitors consumer actions associated with rewards and identifies consumer actions that match required consumer actions defined by the rewards providers. A consumer may perform various actions on a reward offering, e.g., clicking a clickable link of the reward offering, following the instructions in the reward offering to perform various types of actions, such as completing a marketing survey or watching a promotion video. The monitoring module 206 compares the monitored consumer actions of a reward with the required consumer actions specified by the reward provider for the reward. Responsive to the consumer having performed the required consumer actions, the monitoring module 206 communicates with the reward distribution module 208 for providing the reward to the consumer, e.g., adding free mobile airtime to the consumer's mobile service plan.

The reward distribution module 208 verifies consumers and consumer actions and provides rewards to qualified consumers based on verification of the consumers and consumer actions. The reward distribution module 208 may verify the consumers before rewarding the consumer for completing the required consumer actions of rewards. In one embodiment, the reward distribution module 208 verifies the consumer using the consumer information stored in the consumer profile store 212 and verifies the consumer actions using the reward information stored in the reward store 214. In another embodiment, the reward distribution module 208 sends a verification request to the reward provider 110, which verifies the consumer and consumer actions using the information stored at the reward provider 110.

The reward distribution module 208 may provide a reward to a qualified consumer in various ways, for example, through prepaid mobile airtime, electronic money transfer (e.g., PayPal credits), or any form of online e-check. The reward distribution module 208 distributes rewards to mobile devices of the consumers through various communication means. For example, a reward can be sent to consumers directly via short message service (SMS), instant messages, emails, phone calls, tweets, posts or newsfeeds on social networking systems, or any other messages supported by the consumers' mobile devices.

The reward distribution module 208 may also aggregate the information on consumers, their purchase history and reward redemptions and transmit the data to the mobile carriers, product manufacturers, brand owners, or any third-party entities that facilitate the reward programs. The mobile carriers, product manufacturers, and brand owners can analyze the data and study the service/brand visibility, such as who is buying their product and where the product is bought. Consumers can register at the reward server 130 to start receiving reward offerings. The mobile carriers, product manufacturers, and brand owners can increase their consumer base by servicing new consumers who were discovered by the reward server 130. For example, consumers who have registered with the reward server 130 can be selected to receive future reward offerings based on their demographic information and/or purchase history.

The reward distribution module 208 gets payment from reward providers 110 for acting as a proxy for the reward providers 110. In one embodiment, the reward distribution module 208 sends a payment request to a reward provider 110 regarding a consumer redeeming a reward provided by the reward provider 110. The operator of the reward server 130 may get paid differently for different reward offerings. For example, when doing a marketing campaign for a service provider (e.g., offering consumers mobile airtime for completing a campaign survey), the operator of the reward server 130 gets paid as market research company, per completed survey. When conducting advertisement campaigns for product manufactures, the operator of the reward server 130 may get paid based on per person reached or per item purchased by the consumer.

To further illustrate the modules of the reward server 130, the following is an example of distributing rewards of free mobile airtime provided by a brand owner to prepaid subscribers of a mobile carrier. The brand owner offers free mobile airtime to the prepaid subscribers through the reward server 130 and requires the prepaid subscribers to complete a marketing survey regarding a product that may be interesting to the subscribers in order to receive the free mobile airtime. The reward presentation module 204 presents the reward of the free mobile airtime as a clickable link on a webpage of the website managed by the reward server 130. Clicking the link of the reward by a subscriber launches a webpage of the marketing survey to the subscriber and instructions on how to answer questions in the marketing survey. If the subscriber wants to receive the free mobile airtime, the subscriber may complete the survey and submit to the reward server 130.

The monitoring module 206 monitors the consumer actions associated with the reward offering. Upon completion of the marketing survey, the reward distribution module 208 verifies the subscriber and provides the reward to the subscriber by adding the free mobile airtime to a subscriber's pre-paid mobile service account. The reward distribution module 208 communicates with the brand owner requesting payment for providing the reward to the consumers for the benefits of the brand owner.

### Exemplary Methods of Providing Rewards in Exchange for Preferred Consumer Actions

FIG. 3 is a flowchart illustrating a method for providing a reward to consumers based on consumer actions with a clickable link of the reward according to one embodiment. In the described embodiment, the steps of the method are performed by the reward server 130. Other embodiments may include different and/or additional steps than the ones described herein.

Initially, the reward server 130 obtains 302 a reward offering from a reward provider, e.g., a product manufacturer. The reward providers provide reward information, such as value of the reward, and required consumer actions (e.g., completing a marketing survey) in exchange for the reward. The reward server 130 creates 304 a clickable link for the reward (e.g., a URL to a webpage having the reward information) and presents 306 the clickable link to a client device of the consumer, e.g., the consumer's mobile phone. The reward server 130 converts the value of the reward in various currencies into a uniform format, e.g., number of minute of free mobile airtime.

The reward server 130 monitors 308 the consumer actions with the clickable link. Clicking the link by the consumer may prepare the consumer to perform a required consumer action associated with the reward, such as conducting a marketing survey specified by the reward provider. Responsive to the consumer having performed the required consumer action 310, the reward server 130 verifies 312 the consumer and the consumer actions. In one embodiment, the reward server 130 uses stored consumer information to verify the consumer and the stored reward information to verify the consumer action. Responsive to the verification of the consumer and the consumer action, the reward server 130 provides 314 the reward to the verified consumer.

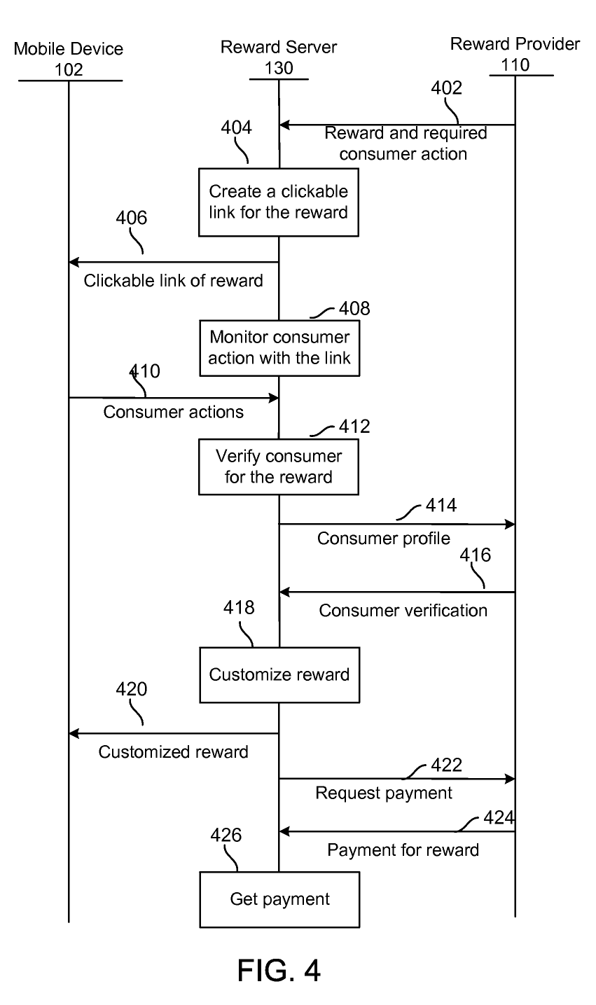

FIG. 4 illustrates interactions among a consumer of a mobile device 102, a reward server 130, and a reward provider 110 for reward distribution according to one embodiment. Initially, the reward server 130 obtains 402 a reward offering and required consumer actions associated with the offering from the reward provider 110. The reward server 130 creates 404 a clickable link for the reward offering and sends 406 the clickable link to the mobile device 102 of the consumer.

The reward server 130 monitors 408 the consumer actions associated with the clickable link. Upon detecting 410 the consumer actions performed by the consumer of the mobile device 102, the reward server 130 verifies 412 the consumer. In one embodiment, the reward server 130 sends 414 a request for verifying the consumer to the reward provider 110, where the reward provider 110 instructs 416 the reward server 130 how to reward the consumer upon verification. For example, the reward provider 110 instructs the reward server 130 on whether to reward the consumer and how much to pay the consumer in terms of free mobile airtime. The reward server 130 may further request the reward provider 110 to verify the consumer actions associated with the offering.

The reward server 130 may further customize 418 the reward offerings for the consumer, such as converting the value of the reward into free mobile airtime, finding a suitable way to deliver the reward to the consumer based on the consumer's demographic information. The reward server 130 presents 420 the customized reward to the consumer and requests 422 payment for acting as the proxy for the reward provider 110. The reward provider 110 verifies the payment request and pays 424 the operator of the reward server 130. The reward server 130 receives 426 the payment from the reward provider 110 for the operator of the reward server 130.

Distributing rewards to consumers through the disclosed reward server 130 enhances the consumer experience by providing an easy access to various reward offerings from reward providers and by shielding the consumers from complicated communications, such as billing, directly with the reward providers. On the other hand, the solution provides an effective reward platform for reward providers to effectively reach a large number of targeted consumers of the reward providers.

### Additional Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, or it may comprise a general-purpose computing device selectively activated or reconfigured by a computer program stored in the computer. Furthermore, any computing systems referred to in the specification may include a single processor or may be architectures employing multiple processor designs for increased computing capability. Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes rather than to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for distributing rewards to consumers, the method comprising:
presenting a clickable link for a reward associated with one or more products or services to mobile devices of a plurality of consumers, the reward having a plurality of consumer actions specified by a provider of the reward;
monitoring consumer actions related to the clickable link;
validating the consumers and associated consumer actions related to the clickable link; and
responsive to validated consumers and consumer actions, providing reward to the consumers.

2. The method of claim 1, wherein the clickable link of the reward is sent to the plurality of consumers by at least one of: short message service (SMS), instant messages, emails, phone calls, tweets, and posts or newsfeeds on social networking systems.

3. The method of claim 1, further comprising:
creating the clickable link of the reward associated with one or more products or services.

4. The method of claim 3, wherein creating the clickable link of the reward comprises converting the value of the reward in one or more currencies into a uniform format, wherein the uniform format is represented by a predefined amount of free mobile airtime of a mobile service.

5. The method of claim 1, wherein the plurality of consumer actions comprises at least one of the following types of consumer actions:
a trial of one or more products or services associated with the reward;
an engagement of an event related to the reward;
a promotion of one or more products or services associated with the reward; and
a purchase of one or more products or services associated with the reward.

6. The method of claim 1, further comprising:
collecting consumer information, the consumer information being represented by a plurality of data fields of a consumer profile associated with a consumer; and
storing reward information, the reward information describing a plurality of characteristics of a reward.

7. The method of claim 6, further comprising:
verifying a consumer based on the consumer information associated with the consumer; and
verifying a consumer action based on the reward information associated with the reward.

8. The method of claim 1, further comprising:
requesting payment from a reward provider for distributing a reward provided by the reward provider.

9. The method of claim 8, wherein the payment from the reward provider varies depending at least, in part, on the type of reward.

10. The method of claim 1, further comprising selecting a target consumer for a future reward based on consumer demographics, consumer actions, and product purchase and reward redemption history.

11. A non-transitory computer-readable storage medium storing executable computer program instructions for distributing rewards to consumers, the computer program instructions comprising instructions for:
presenting a clickable link for a reward associated with one or more products or services to mobile devices of a plurality of consumers, the reward having a plurality of consumer actions specified by a provider of the reward;
monitoring consumer actions related to the clickable link;
validating the consumers and associated consumer actions related to the clickable link; and
responsive to validated consumers and consumer actions, providing reward to the consumers.

12. The computer-readable storage medium of claim 11, wherein the clickable link of the reward is sent to the plurality of consumers by at least one of: short message service (SMS), instant messages, emails, phone calls, tweets, and posts or newsfeeds on social networking systems.

13. The computer-readable storage medium of claim 11, further comprising computer program instructions for:
creating the clickable link of the reward associated with one or more products or services.

14. The computer-readable storage medium of claim 13, wherein the computer program instructions for creating the clickable link of the reward comprise computer program instructions for converting the value of the reward in one or more currencies into a uniform format, wherein the uniform format is represented by a predefined amount of free mobile airtime of a mobile service.

15. The computer-readable storage medium of claim 11, wherein the plurality of consumer actions comprises at least one of the following types of consumer actions:
a trial of one or more products or services associated with the reward;
an engagement of an event related to the reward;
a promotion of one or more products or services associated with the reward; and
a purchase of one or more products or services associated with the reward.

16. The computer-readable storage medium of claim 11, further comprising computer program instructions for:
collecting consumer information, the consumer information being represented by a plurality of data fields of a consumer profile associated with a consumer; and
storing reward information, the reward information describing a plurality of characteristics of a reward.

17. The computer-readable storage medium of claim 16, further comprising computer program instructions for:
verifying a consumer based on the consumer information associated with the consumer; and
verifying a consumer action based on the reward information associated with the reward.

18. The computer-readable storage medium of claim 11, further comprising computer program instructions for requesting payment from a reward provider for distributing a reward provided by the reward provider.

19. The computer-readable storage medium of claim 18, wherein the payment from the reward provider varies depending at least, in part, on the type of reward.

20. The computer-readable storage medium of claim 11, further comprising computer program instructions for selecting a target consumer for a future reward based on consumer demographics, consumer actions, and product purchase and reward redemption history.
